(19) United States
(12) Patent Application Publication
(10) Pub. No.: US 2007/0208641 A1
(43) Pub. Date: Sep. 6, 2007

(54) Automated loan processing system and method for processing loans

(75) Inventors: David Smith, Coral Gables, FL (US); Aaron Joyce, Miami, FL (US); Roy Matthew, Miami, FL (US); Aruna Chandrasekharan, Doral, FL (US)

Correspondence Address: MAYBACK & HOFFMAN, P.A., 5722 S. FLAMINGO ROAD #232, FORT LAUDERDALE, FL, 33330, US

(73) Assignee: Bayview Lending Group LLC

(21) Appl. No.: 11/713,482

(22) Filed: Mar. 2, 2007

Related U.S. Application Data
(60) Provisional application No. 60/778,851, filed on Mar. 3, 2006.

(51) Int. Cl. G06Q 40/00

(52) U.S. Cl. 705/35

(57) ABSTRACT

A method for managing loan processing workflow includes a workflow of a logical sequence of interdependent tasks to be performed to complete processing of a loan from initial input to closing. The workflow has tasks and notifications. Each task has an associated status, either resolved or not resolved. Related tasks and notifications are grouped into sets. The workflow tasks are displayed in a logical order and upon satisfaction of predetermined conditions. At least one of the displayed tasks requires input from a user to set the status and a user changes the status of the task to resolved. One or more notifications linked to certain of the workflow tasks are output and do not require input from a user. A loan application is processed through the workflow. All tasks can require resolved status before displaying the next one and each can require input from a user.

### CROSS-REFERENCE TO RELATED APPLICATION

This application claims the priority, under 35 U.S.C. §119, of U.S. Provisional Patent Application Ser. No. 60/778,851, filed Mar. 3, 2006, the entire disclosure of which is hereby incorporated herein by reference in its entirety.

### BACKGROUND OF THE INVENTION

### FIELD OF THE INVENTION

The present invention relates to an automated loan processing system and a method for processing loans, in particular, commercial loans.

Processing loan applications is a complicated procedure involving numerous tasks that must be completed in a particular order. The process involves a multitude of steps, including the general steps of application, loan processing, underwriting, and closing. Multiple groups within or outside a lending organization generally perform these tasks. For example, loan officers typically work with applicants to complete the application. An underwriter or underwriter group decides whether or not to approve loan based on information from the application and internal guidelines, and external information such as appraisals and the like. Generally, each task involves many steps which are conventionally performed manually by various people. The necessary participation between various work groups makes it difficult to manage the complicated loan process.

Moreover, in previous systems for processing loans, a loan processor (a person) physically inputted customer data, into a database (such as an EXCEL® spreadsheet, for example). This information was hand-converted into a text document (e.g., a WORD® document) so that the information could be text processed. Finally, the text document was hand-converted into data that could be input into a loan processing software, such as Dynatek's MORvision™, an off-the-shelf loan processing software program. Each step in this process required a substantial amount of human effort. This human factor introduced a large amount of cost and time. Additionally, the security of such information was limited or was non-existent, as any confidential data contained in any of the spreadsheet or text documents was easily discoverable with commonly known computer techniques. A business rules engine, a software system that helps manage and automate business rules, is often used to implement rules for loan processing and approval. The rule engine applies rules and actions as defined by end users without affecting how the application runs. A rule engine can be viewed as a sophisticated interpreter of if-then statements. The application is built to deal with the rules, which are designed separately. The rules a business follows may come from legal regulation (e.g., “maximum interest rates”), company policy (e.g., “discounts to repeat customers”) or other sources. The Rule Engine software, among other functions, helps to manage all these rules and provides for consistency.

Most rules engines function as a callable library. The Rules engine interfaces with the application code to apply the rules to user input. For example, rule-based applications communicate with the rule engine by passing in the set of rules to be executed. Then, the application can inspect the results and either display them to the end user or perform further processing. The rule engine determines when to evaluate each rule based on the input required for the rule as well as the results obtained from the evaluation of previous rules. Corticon Business Rule Server (Corticon Technologies, Inc., San Mateo, Calif.) is an example of a commercially available business rules engine that takes an XML request as an input, applies the rule, and returns an XML response as output. Unfortunately, when using a web application interface with a Rules Engine, entire HTML pages must be reloaded to change any portion of the content, including every time the application calls the Rules Engine, and this slows down the process.

It would be desirable, therefore, to provide a system and method for processing loans that reduced the amount of human effort and automated the workflow, thereby, substantially reducing the cost for processing loans.

It would also be beneficial to provide a system and method that increased the security of customer data and the processing of that data when making decisions on whether or not, and/or to what amount and terms, a loan should be offered.

It would also be beneficial to provide a system and method that allowed access to a rules engine through a browser based client/server application without the need to refresh/reload the entire web page each time the rules engine is accessed.

### SUMMARY OF THE INVENTION

It is accordingly an object of the present invention to provide an automated system and method for processing loans that overcome the hereinafore-mentioned disadvantages of the heretofore-known devices and methods of this general type and that reduces the human factor while increasing security of sensitive data. The system of the present invention can be referred to as the Flagship system.

With the foregoing and other objects in view, there is provided, in accordance with the invention, a method, system, and computer product code devices for managing workflow for a loan processing system, including: providing a workflow for a loan processing system including tasks and notifications, the workflow defined as a logical sequence of interdependent tasks to be performed to complete processing of a loan from initial input to closing, each task having an associated status, wherein the status is either resolved or not resolved; grouping related tasks and notifications into sets; displaying one or more of the workflow tasks in a logical order and upon satisfaction of predetermined conditions and wherein at least one of the displayed tasks require input from a user; receiving input from a user to change the status of a task to resolved; outputting one or more notifications linked to certain of the workflow tasks, wherein the notifications do not require input from a user; and processing a loan application through the workflow. Each of the tasks can require a status of resolved before displaying the next one or more of the workflow tasks in the logical order, and each of the displayed tasks requires input from a user.

The sets include one or more of an initial input set, a pre-approval underwriting set, a conditional pre-approval distribution processing set, a loan file assignment set, a processing set, a loan term changing set, an appraisal fee quote request set, an appraisal engagement set, an appraisal review set, an initial final underwriting review phase one set, an initial final underwriting review phase two set, a final review phase one set, a final review phase two set, an ordering title set, a closing set, and a legal transactions set.

With the objects of the invention in view, there is also provided a method, system, and computer program code for dynamically interfacing with a rules engine in a browser-based application such as a loan processing system to update a portion of a webpage without re-loading the entire page including: displaying a user interface in a browser as a webpage including an input field for receiving user input and a results field for displaying the results after application of a rule; in response to the input field receiving user input, executing a request to a rules engine using asynchronous scripting; returning an output to the user interface after application of a rule; and displaying the output in the results field without re-loading the entire webpage. In an embodiment the asynchronous scripting is Asynchronous JavaScript and XML. The results field is a drop down selection box that changes based on the application of the rule. Alternately, the results field can be any portion of the webpage, such as text, images, graphics, etc. wherein only the results field is updated rather than the entire web page.

Other features that are considered as characteristic for the invention are set forth in the appended claims.

Although the invention is illustrated and described herein in certain embodiments, it is not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a flow diagram of the overall process of the system and method according to the invention;

FIG. 2 is a flow diagram of the initial inputting sub-process of FIG. 1;

FIG. 3 is a flow diagram of the pre-approval underwriting and Conditional Pre-Approval Letter (CPL) signing sub-process of FIG. 1;

FIG. 4 is a flow diagram of the CPL distribution sub-process of FIG. 1;

FIG. 5 is a flow diagram of the loan file assignment sub-process of FIG. 1;

FIG. 6 is a flow diagram of the loan processing sub-process of FIG. 1;

FIG. 7 is a flow diagram of the CPL/loan term change sub-process of FIG. 1;

FIG. 8 is a flow diagram of the appraisal fee quote request sub-process of FIG. 1;

FIG. 9 is a flow diagram of the appraisal engagement sub-process of FIG. 1;

FIG. 10 is a flow diagram of the appraisal review sub-process of FIG. 1;

FIG. 11 is a flow diagram of the first phase of the initial final underwriting review sub-process of FIG. 1;

FIG. 12 is a flow diagram of the second phase of the initial final underwriting review sub-process of FIG. 1;

FIG. 13 is a flow diagram of the first phase of the final review sub-process of FIG. 1;

FIG. 14 is a flow diagram of the second phase of the final review sub-process of FIG. 1;

FIG. 15 is a flow diagram of the ordering title sub-process of FIG. 1;

FIG. 16 is a flow diagram of the closing sub-process of FIG. 1;

FIG. 17 is a flow diagram of the legal transactions sub-process of FIG. 1; and

FIG. 18 is a flow diagram of an exemplary embodiment of the system and method according to the invention.

### DETAILED DESCRIPTION OF THE PREFERRED EMBODIMENTS

While the specification concludes with claims defining the features of the invention that are regarded as novel, it is believed that the invention will be better understood from a consideration of the following description in conjunction with the drawing figures.

Before the present invention is disclosed and described, it is to be understood that the terminology used herein is for the purpose of describing particular embodiments only and is not intended to be limiting. It must be noted that, as used in the specification and the appended claims, the singular forms “a,” “an,” and “the” include plural references unless the context clearly dictates otherwise.

The present invention can be realized in hardware, software, or a combination of hardware and software. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

In various embodiments, the system includes at least one server, and at least one client. In some embodiments, communication among the server and one or more of the clients utilizes a communications network. In one exemplary embodiment, the client computer includes a browser, client software, or both. The browser allows the client to request a web page or other downloadable program, applet, data, or document (e.g., from the server) with a web page request. One example of a web page is a data file that includes computer executable or interpretable information, graphics, sound, text, and/or video, that can be displayed, executed, played, processed, streamed, and/or stored and that can contain links, or pointers, to other web pages. In one embodiment, a user of the client manually requests a web page from the server. Alternatively, the client automatically makes requests with the browser. Examples of commercially available browser software are INTERNET EXPLORER, offered by Microsoft Corporation, NETSCAPE NAVIGATOR, offered by AOL/Time Warner, and FIREFOX offered by the Mozilla Foundation.

In some embodiments, the client also includes client software. The client software provides functionality to the client that allows a user to utilize the features of the invention. The client software may be implemented in various forms, for example, it may be in the form of a Java applet that is downloaded to the client and runs in conjunction with the browser, or the client software may be in the form of a standalone application, implemented in a multi-platform language such as Java or in native processor executable code. In one particular example, the applet may be implemented as an information screen within a separate application using, for example, asynchronous JavaScript and XML (“AJAX”) such that many of the user-initiated actions are processed at the client. In such cases, data may be exchanged with the server behind the scenes and web pages being viewed by users at the clients need not be reloaded each time a change is made, thus increasing the interactivity, speed, and usability of the system. In one embodiment, if executing on the client, the client software opens a network connection to the server over communications network and communicates through that connection to the server.

The client software and the browser may be part of a single client-server interface.

The communications network connects the client with the server. The communication may take place through any media such as standard telephone lines, a local or wide-area network (LAN or WAN links such as T1, T3, 56 kb, X.25), broadband connections (ISDN, Frame Relay, ATM), wireless links (cellular, 802.11, Bluetooth, etc.), and so on. In one exemplary embodiment, the network facilitates the transmission of TCP/IP protocol communications and HTTP/HTTPS requests made by the browser, and the connection between the client software and the server can be communicated over such TCP/IP networks. The type of network is not a limitation, however, and any suitable network may be used. Non-limiting examples of networks that can serve as or be part of the communications network include a wireless or wired Ethernet-based intranet, LAN or WAN, and/or the global communications network known as the Internet, which may accommodate many different communications media and protocols.

The server interacts with one or more clients. The server is, in one exemplary embodiment, implemented on one or more server class computers that have sufficient memory, data storage, and processing power and that run a server-class operating system (e.g., SUN Solaris, GNU/Linux, and the MICROSOFT WINDOWS family of operating systems). Other types of system hardware and software than that described herein may also be used, depending on the capacity of the device and the number of users and the size of the user base. For example, the server may be or may be part of a logical group of one or more servers such as a server farm or server network. As another example, multiple servers can be associated or connected with each other, or multiple servers may operate independently, but with shared data. In a further embodiment, and as is typical in large-scale systems, application software is implemented in components, with different components running on different server computers, on the same server, or some combination.

A workflow server (WFS) may be used as the backbone of a workflow system with Internet and/or Intranet access. Users may interact with the system using a browser. The WFS may receive requests in the form of formatted strings and the like from a browser. A request received from a browser is usually passed to an Application Request Server (ARS) or the like, which converts the request into a formatted message and passes it to a Workflow Engine for processing. The WFS is generally linked to a database and/or Rules Engine, which stores the workflow information and business rules. The Workflow Engine then retrieves data from the database and/or applies rules to the request and passes to the ARS. The ARS may then create a browser readable page or portion of a page using the data/rules and pass it back to the browser for display by the user.

The present invention can also be embedded in a computer program product, which includes all the features enabling the implementation of the methods described herein, and which—when being loaded in a computer system—is able to carry out these methods.

Computer program means or computer program in the present context means any expression, in any language, code or notation, of a set of instructions intended to cause a system having an information processing capability to perform a particular function either directly or after either or both of the following: (a) conversion to another language, code or notation; and (b) reproduction in a different material form.

Portions of the loan processing system are, in one exemplary embodiment, browser-based. With respect to the initial input of data, the present invention allows the customer data to be inputted into a rule engine though a web interface through XML. In accordance with a presently preferred embodiment of the present invention, the components, process steps, and/or data structures are implemented using the XML programming language. This implementation is not intended to be limiting in any way. Different implementations may be used and may include other types of operating systems, computing platforms, and/or computer programs.

The information, including deal structure, static inputs, credit, income, property, and RCO (REO), is sent electronically over the Internet to a secure site at which the rule engine resides. While an exemplary system carrying the rule engine is known (see, e.g., the CORTICON rule engine system), the rules that are placed inside the engine are custom-made and custom tailored to the particular process because it is the user of the rule engine that creates the rule sets in accordance with internal and external business rules. The business defines its own rule structure for rules that may be executed by the rules engine. Corticon Business Rule Server, for example, can be used to take an XML request as an input and return an XML response as output. It is called as either an inline java “jar” file from a java application, or as a web service from any application that can consume web services. See U.S. Pat. No. 7,020,869 to Corticon Technologies, Inc., the entire disclosure of which is hereby incorporated herein by reference.

Once the rule engine processes the data, it outputs—again through XML—approval data through the web interface. This custom output data includes, for example, a score, an interest rate, and a margin along with a matrix of numbers for each of these variables based upon the kinds of products that are available (e.g., a 6-month loan, a 2-year loan, and/or a 3-year loan).

An XML interface is reasonably secure in that it is difficult to intercept the XML data that is being sent over the web from the loan processor (an employee or a mortgage broker) to the rule engine or from the rule engine back to the loan processor. The rule engine, itself, is entirely secure as it only receives input variables and transmits output variables. Thus, security of the loan processing system is enhanced significantly over prior systems.

Based upon the nature of the XML information, once the data is keyed into the system, there is no duplicate keying in of this data again (as compared to the previous systems mentioned above). Thus, the present invention entirely eliminates the prior art need for multiple data entries by a human.

The invention includes a method of dynamically interfacing with the rules engine to update a portion of the webpage without re-loading the entire page. The method includes displaying a user interface in a browser as a webpage including an input field for receiving user input and a results field for displaying the results after application of a rule; in response to the input field receiving user input, it executes a request to a rules engine using asynchronous scripting; it then returns an output to the user interface after application of a rule or rules; and then displays the output in the results field without re-loading the entire webpage. In an embodiment, the asynchronous scripting is Asynchronous JavaScript and XML. If the results field is a drop down selection box, the selections in the box will change based on the application of the rule. Other results fields may be utilized, including text, images, graphics, etc. as known in the art, wherein only that field is updated rather than the entire web page.

For example, AJAX, a web development technique for creating interactive web applications, may be used. The intent is to make web pages feel more responsive by exchanging small amounts of data with the server behind the scenes, so that the entire web page does not have to be reloaded each time the user requests a change. This process increases the web page's interactivity, speed, and usability. AJAX is not a technology in itself, but a term that refers to the use of a group of technologies.

A user-initiated event on the browser-based user interface (UI) causes AJAX to execute a request to the web server, which in turn communicates with the application server. On the application server, the Rules Engine (e.g., Corticon) takes XML as an input and returns XML as an output. It passes that response back to the application server, which hands it back to the web server, which serves up XML to the browser. Without refreshing the whole page (as would happen with a normal web server response), the browser uses the XML response to refresh a small portion(s) of the HTML that needs to change based on the business rules (e.g., results field(s)).

In a specific example of applying the method of dynamically interfacing with the rules engine to update a portion of the webpage without re-loading the entire page, the system could include the following Business Rule: “For loans on multi-family properties in New Jersey with six units or fewer, a prepayment option is not allowed, making the only valid choice “None” in the results field. When the number of units exceeds six, the choices in the results field, here a drop down list, are:

“None,” “3 Year Lock-Out,” “7 Year Lock-Out,” “3 Year Prepayment with 3 Year Lock-Out,” “5, 4, 3, 2, 1 Prepay,” and “5, 4, 3, 2, 1 with 3 Year Lock-Out.”

When applying this Business Rule, if the Total Units is “5” the only choice in the results field (e.g., dropdown list) would be “None.” If the user changes the value for Total Units from “5” to “7” in the input field, the business rule is applied and another set of values is returned, replacing the values in the results field (dropdown box) with “None,” “3 Year Lock-Out,” “7 Year Lock-Out,” “3 Year Prepayment with 3 Year Lock-Out,” “5, 4, 3, 2, 1 Prepay,” and “5, 4, 3, 2, 1 with 3 Year Lock-Out.” By utilizing AJAX to execute a request to the web server, the changes in the results field (drop down box) are implemented without refreshing the entire page.

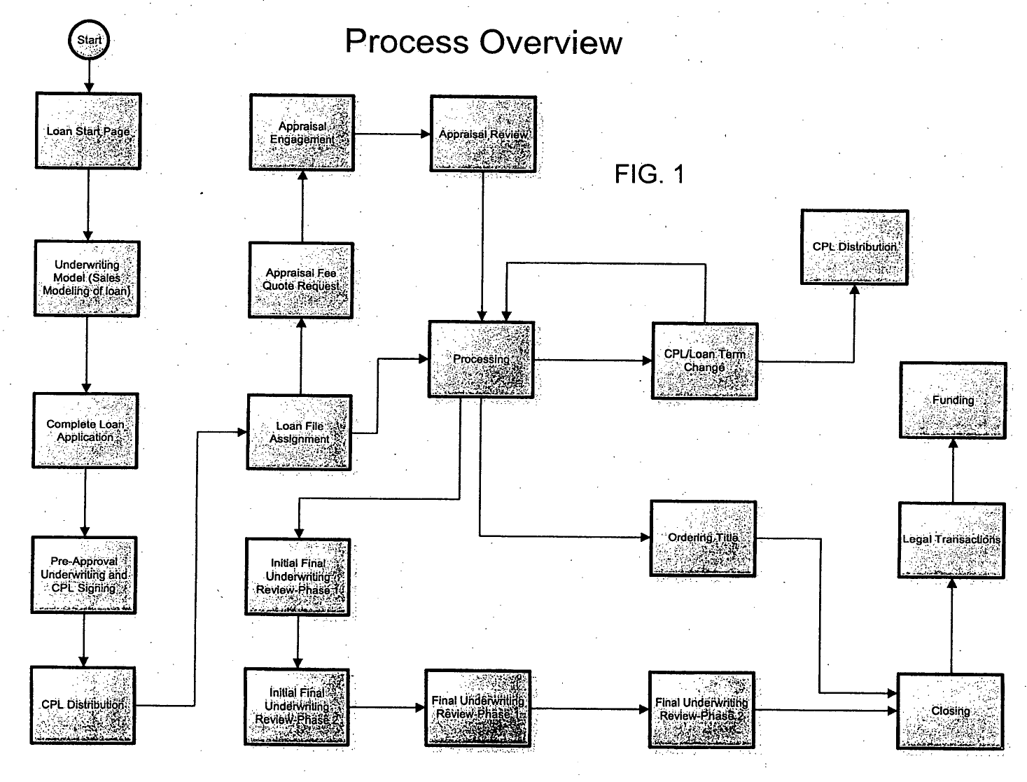

Referring now to the figures of the drawings in detail and first, particularly to FIG. 1 thereof, there is shown a flow diagram of an overview of an exemplary embodiment of the system and process of the present invention.

A salesperson receives a loan deal either through the mail, over the phone, or through an Internet lead. The salesperson then speaks with a loan broker to get more information on the deal and to see if it will fit one of the available loan programs. If the deal does fit one of the programs, then the loan process begins.

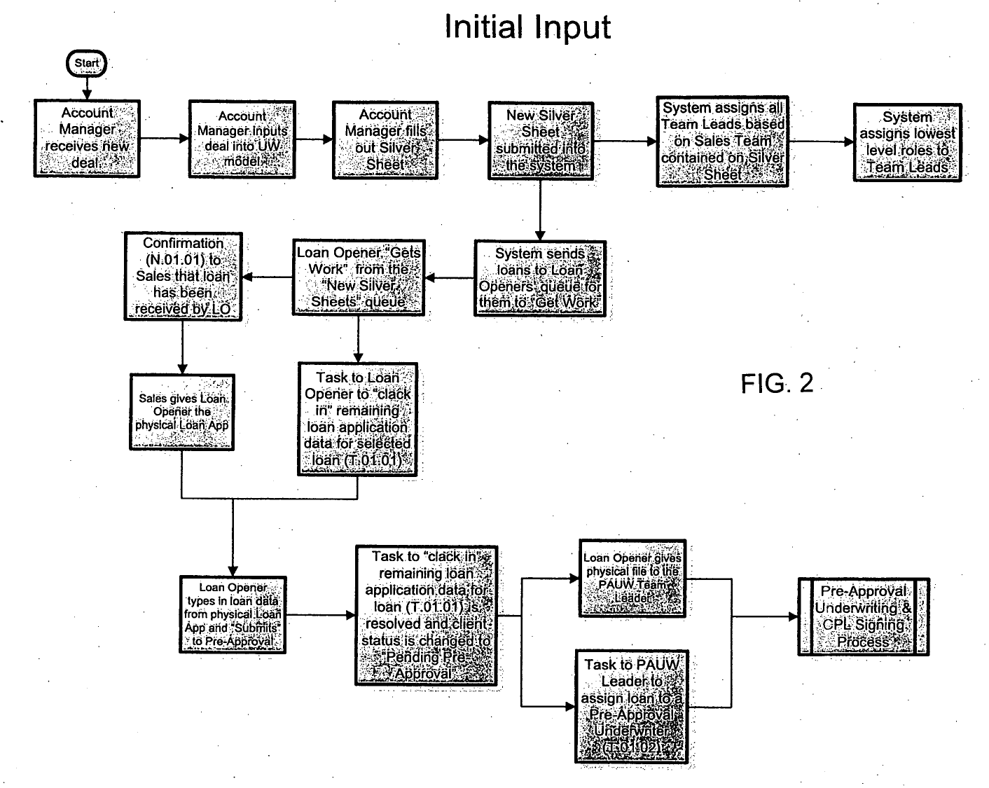

The loan process starts, as shown in FIG. 2, with the salesperson opening a new loan through a Loan Start input page. This page gathers the basic information that is needed to identify a loan.

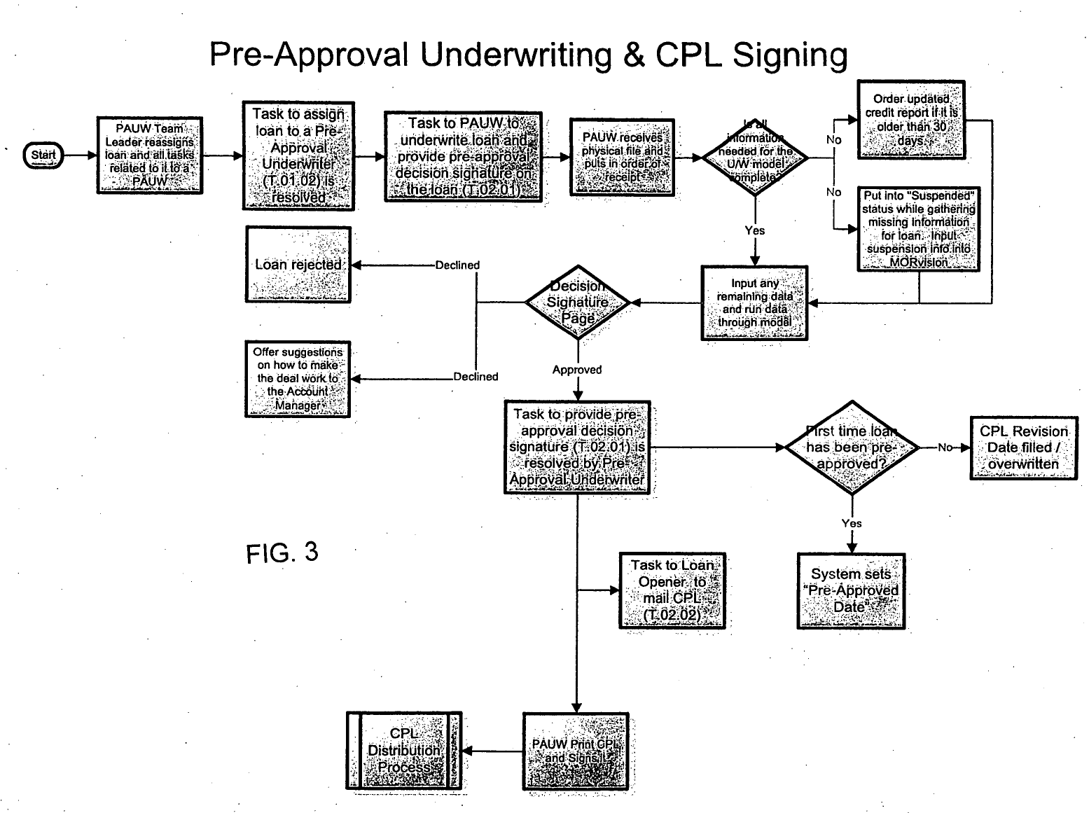

Next, as illustrated in FIG. 3, the salesperson inputs pertinent information into a loan-underwriting model to calculate an interest rate and see if the loan deal will achieve a passing status. Once the model is finished, the salesperson enters the remaining loan application data into the loan processing system and submits it to Pre-Approval Underwriters.

Next, the Pre-Approval Underwriters verify the inputs to the loan underwriting model with respect to the paper application received from the borrower(s). The Underwriters use the most current data provided by the borrower(s) to run the model and obtain a result. If the borrower(s) does not pass the tests in the loan underwriting model, an Underwriter may alter the requested program terms to different terms in order to obtain terms for which the borrower(s) qualify. The Underwriter may also request an exception so that some of the borrower(s) input information is changed to make the deal enter into a pass mode and, in such a case, proof to support the altered data will be required later.

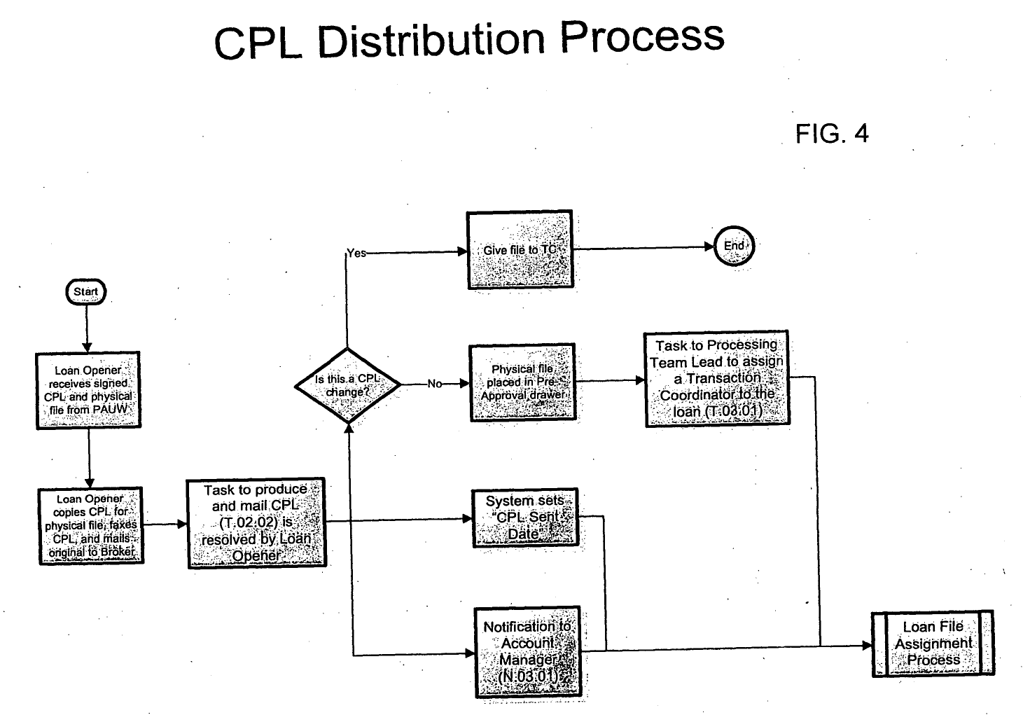

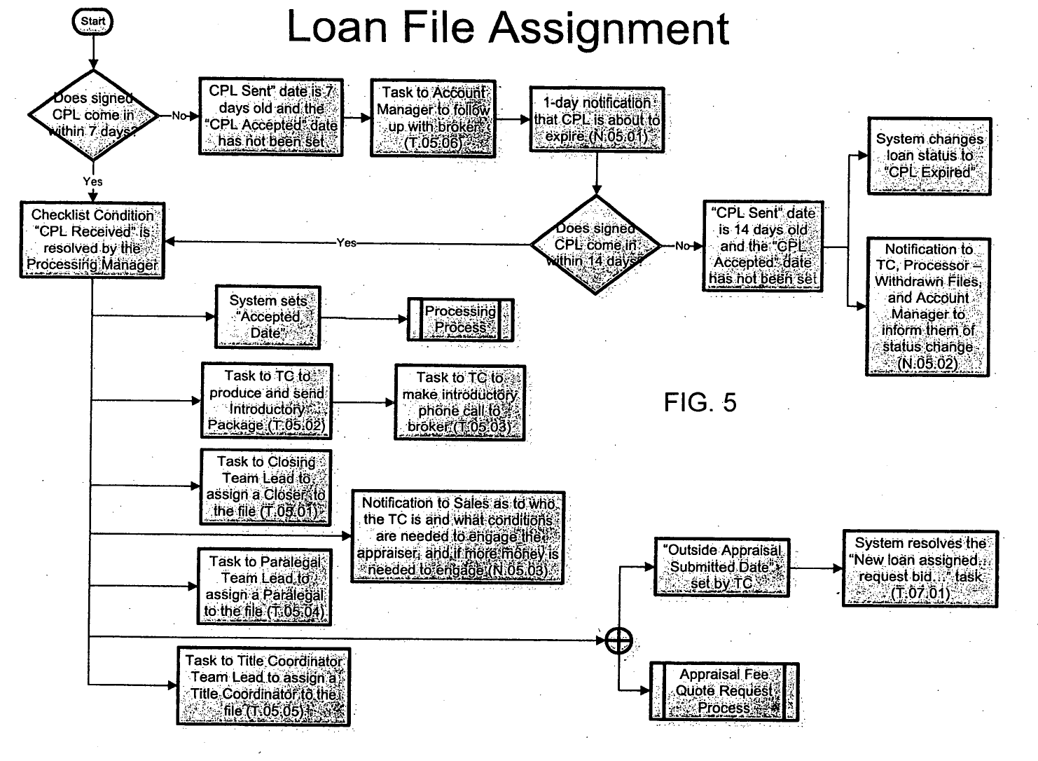

Once the deal has been approved, the Underwriter creates a Conditional Pre-Approval Letter (CPL), signs it, and sends it to the Broker. This sub-process is illustrated in FIG. 4. The loan is now considered as being Pre-Approved. Once the CPL is sent, a file is created for the deal with the loan application forms, a copy of the CPL, and any documentation the borrower(s) sent with the application. The file is, then, assigned to a Transaction Analyst (TA) for subsequent management as shown in FIG. 5. Once the CPL comes back signed, the TA sends this Introductory Package to the Broker, sets the loan to an Accepted status, notifies the salesperson if more documentation or money is needed to engage the appraiser, and makes an introductory call to the Broker. A Closing Manager assigns a Closer to the loan and a Paralegal Team Lead assigns a Paralegal to the loan. If the Closer has a Title Preference Form, then the title is ordered. If the Title Preference Form has not been received at that time, the Closer waits until the Title Preference Form is received before ordering a title.

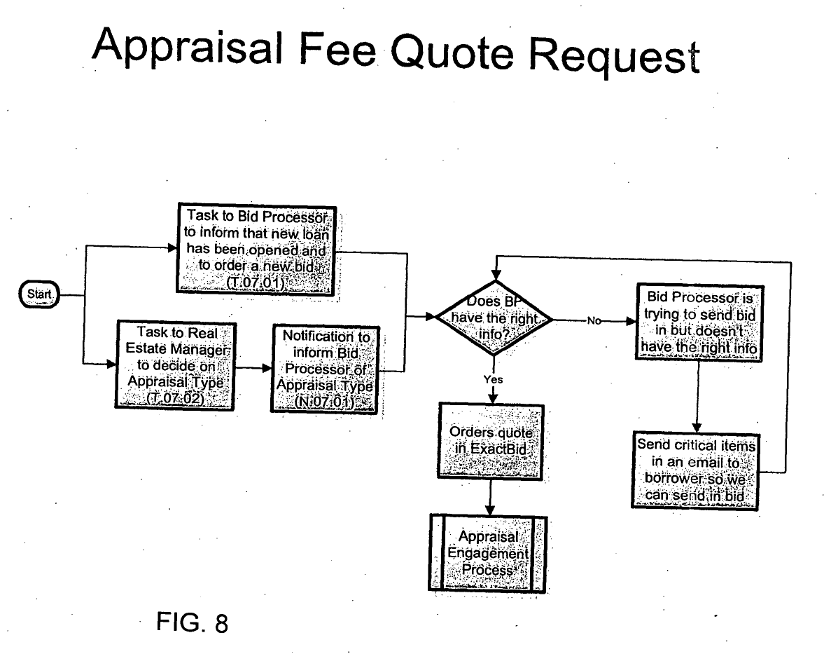

As shown in FIGS. 8 to 10, a Bid Processor (BP) on the loan requests bids for the appraisal. If there is an outside appraisal, it will be submitted to a real estate department for review.

After the BP receives the bids from appraisers, the BP picks the best quote and submits the quote date, amount, and turnaround time to the TA for approval. If the TA does not approve the bid, the BP will have to choose another bid or request additional bids from appraisers. If the TA accepts the bid, then the TA sends an APF Quote Letter to the Broker. Once all of the money and documentation required for the appraisal are received, the TA requests that the appraisal be ordered. This request sets the status of the loan to “Appraisal Ordered” and also sets the Appraisal Ordered date. The BP engages the appraiser and fills in the Report Due Date for the loan.

At this time, an anticipated closing date is set to be ten (10) days after the Report Due Date, and the TA gives the insurance information to the Closer and orders third party services. The Bid Processor follows up with the Appraiser five (5) days prior to the Report Due Date, and one (1) day prior to the Report Due Date if the Appraisal Received Date has not been filled. Once the Appraisal Received Date and a Sticker Value are filled in, an Account Manager and TA will be notified of the Sticker Value. A Real Estate Manager will receive a task to assign a priority level to the appraisal for review by a Real Estate Analyst. Once the Real Estate Analyst has reviewed the appraisal and the Appraisal Complete Date has been entered, a notification will be sent to the Final Underwriter (FUW) notifying it of the final appraisal value.

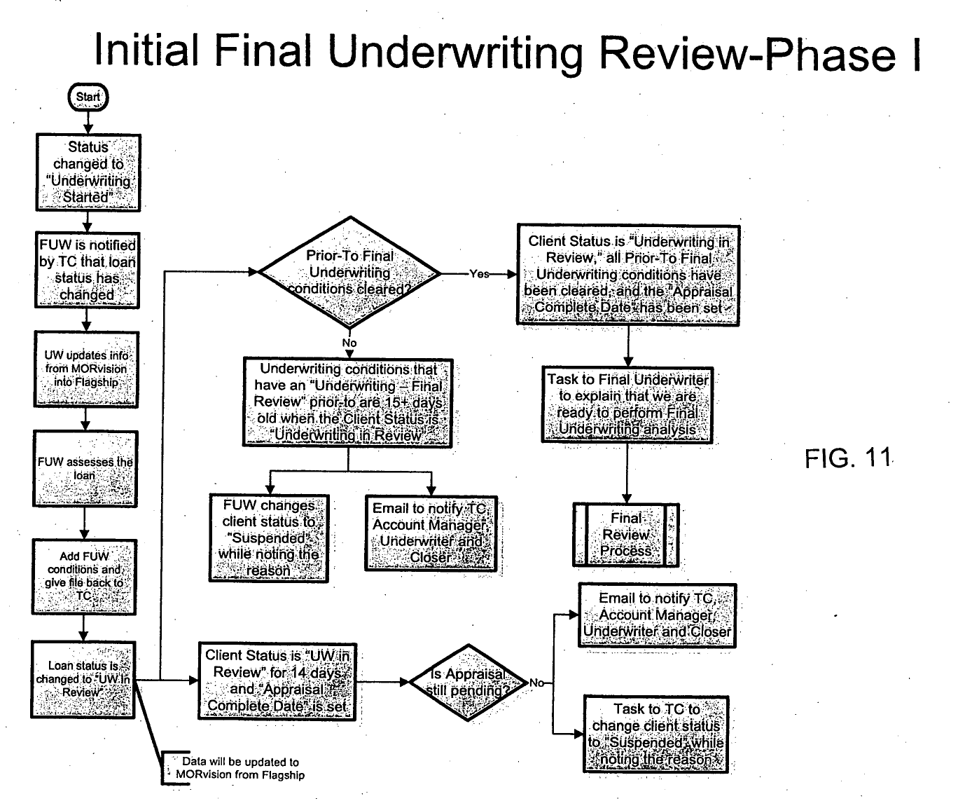

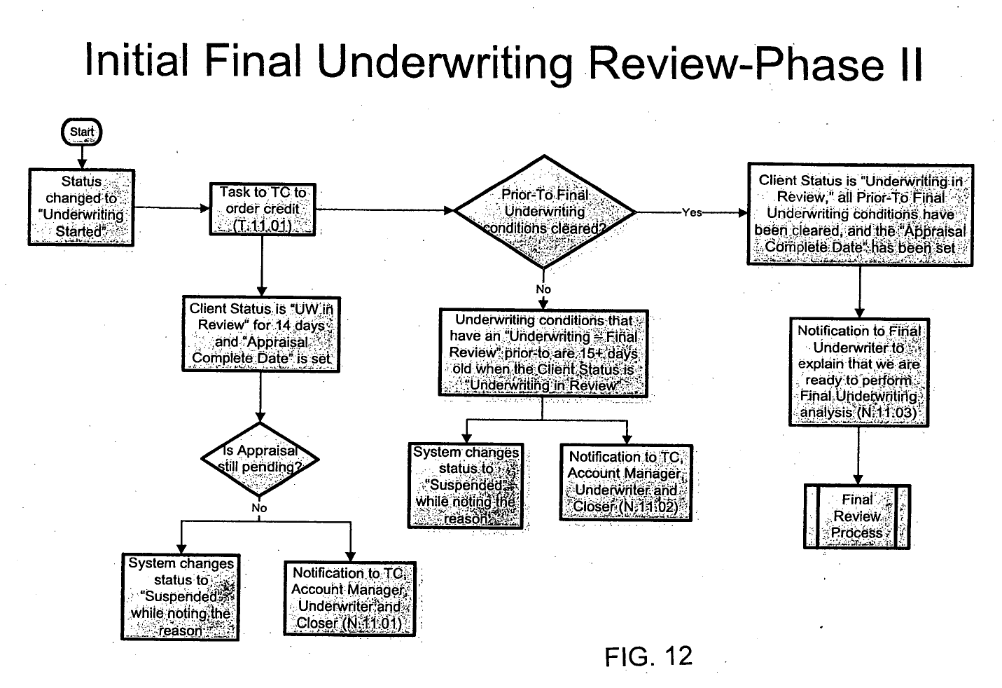

Once the TA has received enough conditions for the FUW to look at the loan, as shown in FIGS. 11 and 12, the TA will order credit on the borrowers and the status will be changed to Underwriting Started. The FUW will, then, assess the loan and add any additional conditions needed for further assessment and give the file back to the TA. The status will, then, change to Underwriting in Review.

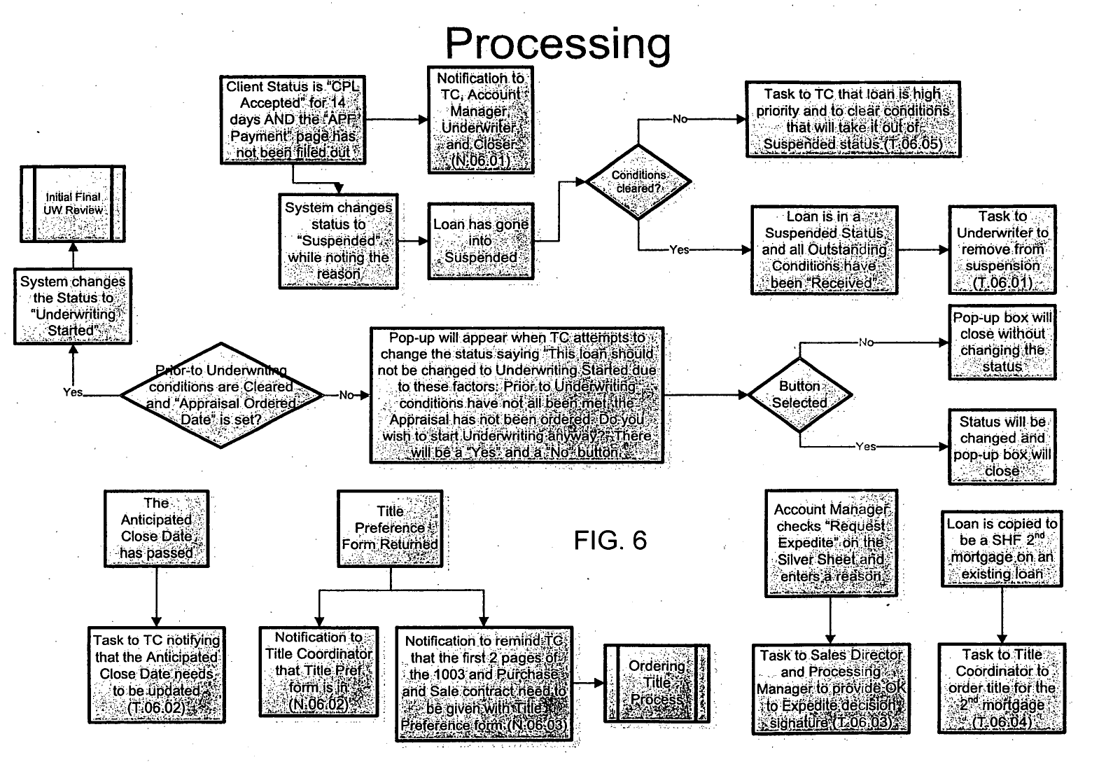

If the loan remains in Underwriting in Review for more than fourteen (14) days without the Appraisal Complete Date being set, the loan will become Suspended. See FIG. 6. Once the Final Underwriting conditions have been cleared and the Appraisal Complete Date has been set, the FUW will perform the final analysis of the loan. If the model outputs a Decline, then the FUW will offer suggestions to the Account Manger on possible scenarios that will work for the customer/applicant.

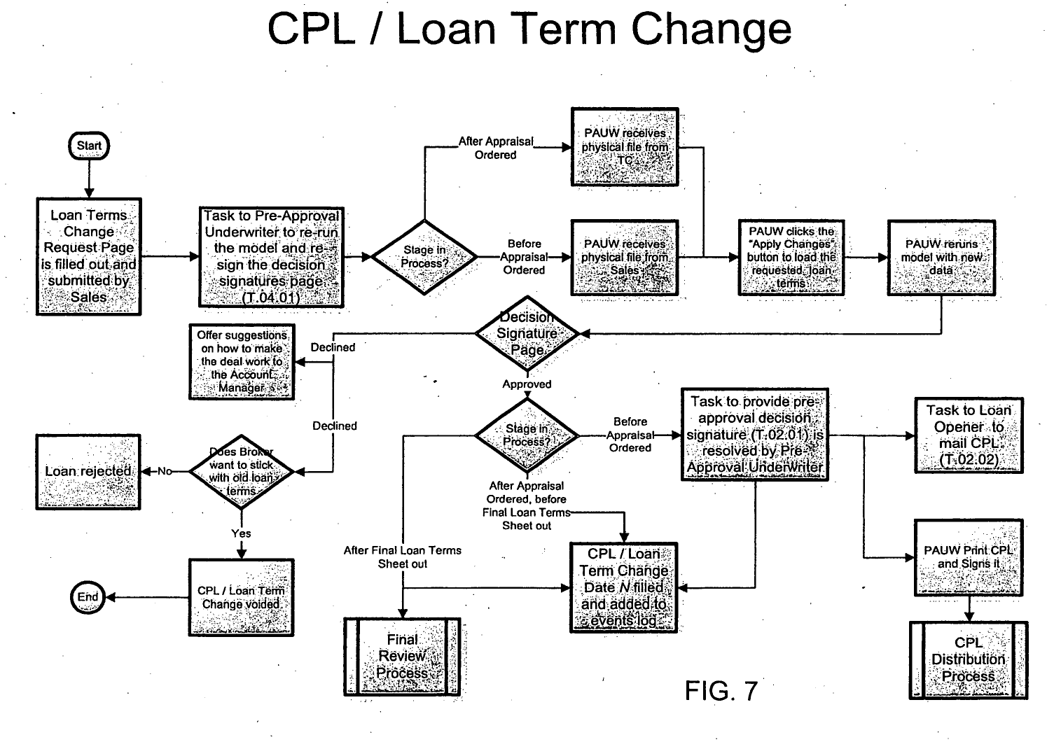

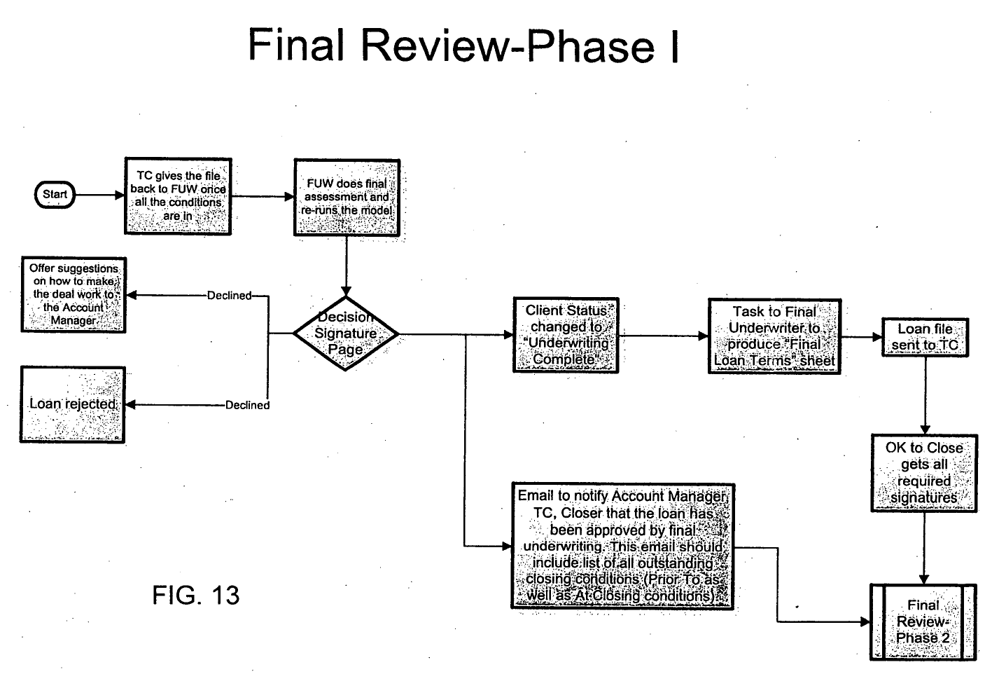

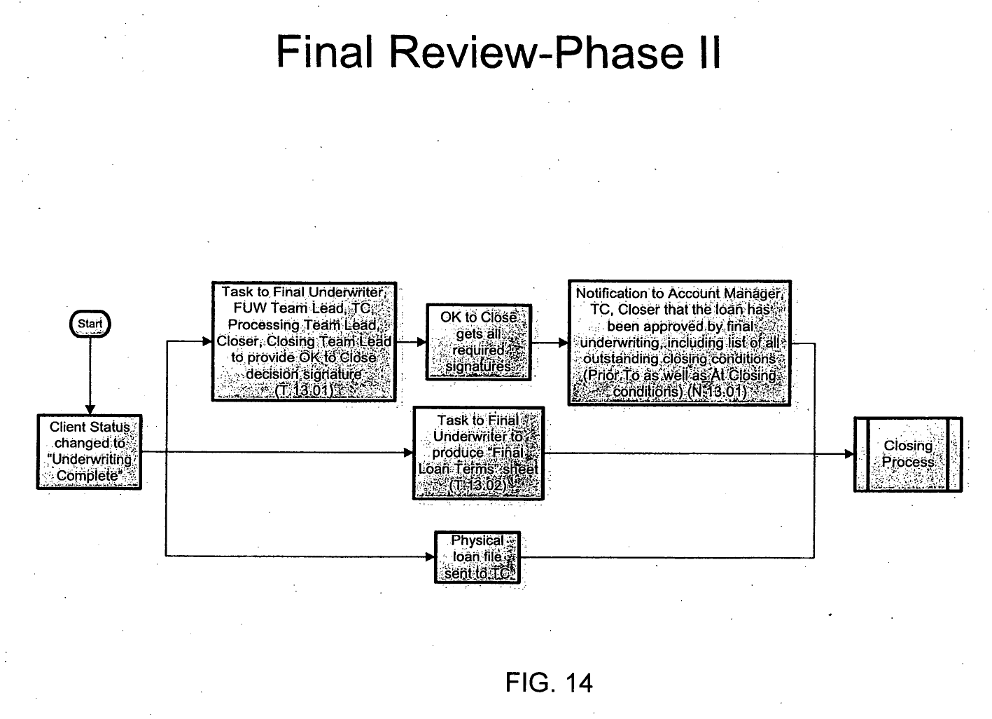

See FIG. 7. If the model outputs an Approved, then the status will be changed to Underwriting Complete, see FIGS. 13 and 14, and the FUW will produce a Final Loan Term sheet, which the Closer will send out. A notification will, then, be sent to the Account Manger, the TA, and the Closer that the loan has been approved. The file will, then, be given back to the TA and the OK to Close form will be signed by all required parties.

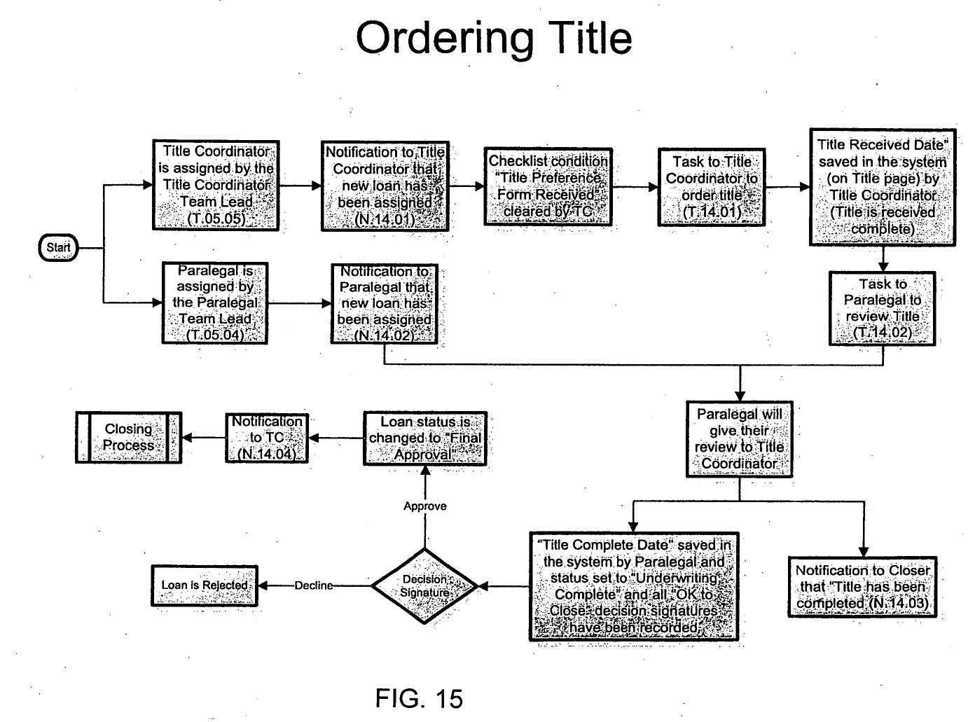

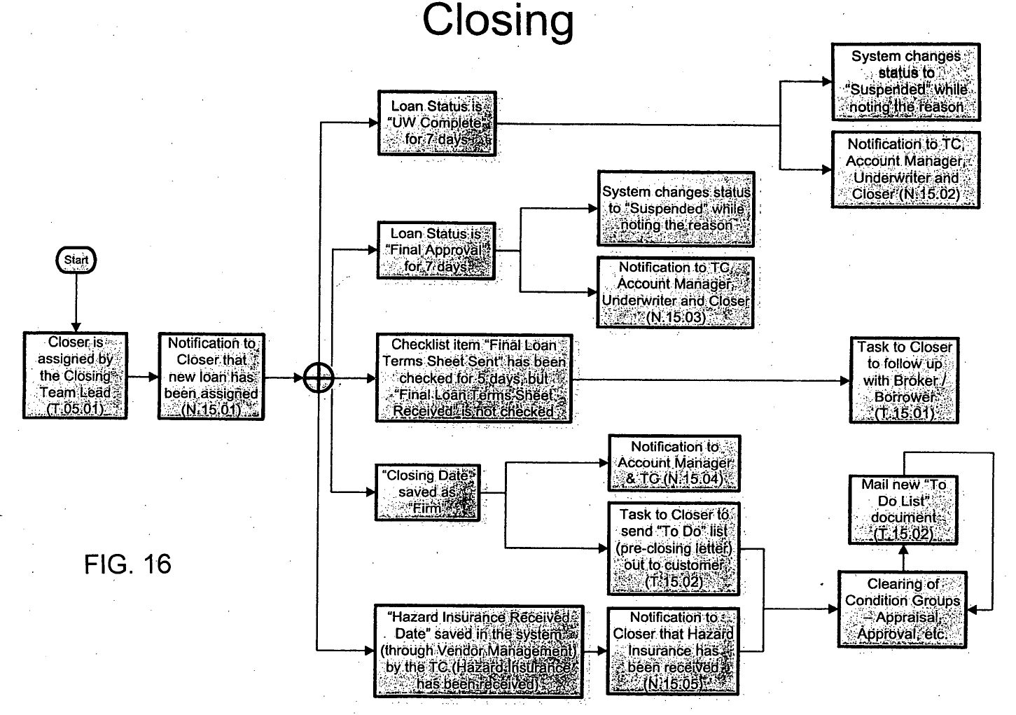

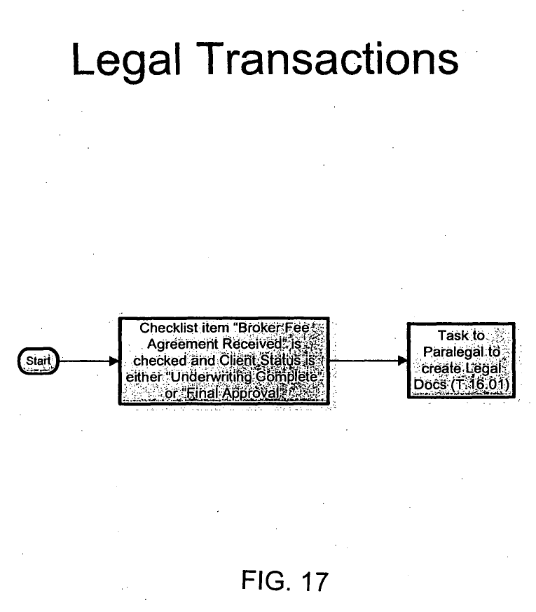

Once the Closer receives the Title Preference Form, the Closer will order title as illustrated in FIG. 15. Once the title has been received, the Closer will fill in the Title Received Date in the system and a task will be sent to the Paralegal to review the title. After the Paralegal has reviewed the title, the Title Complete Date will be filled in and the corresponding review will be given to the Closer. If, at the time, the status of the loan is Underwriting Complete, the status will be changed to Final Approval. Once the loan is in Final Approval, the closing date and time can be set. See FIG. 16. Once a Closing Date has been set to Firm, the closing information will be sent, as shown in FIG. 16, to the Account Manager, a Sales Associate, the TA, and Department Managers, and the Broker Fee Acknowledgement form and a To Do list for closing will be sent to the customer/applicant. The Paralegal will create the Legal Documents, as shown in FIG. 17, and send them to the Closer.

The Closer will review the HUD-1 statement and applicable fees and send the Closing package to a Closing Agent. The Closer will also create Lender documents for a VP of Operations to sign, and mail the Lender documents to the bank. Once the borrower(s) has signed the Closing Documents and the loan has been closed, the status of the loan will be changed to Closed—Not Funded. The Closer will, then, create a Funding Request and send it to the Funding Department. Once the loan has been funded, the status of the loan will change to Funded (Final). At this point the loan will be sent to Post-Closing for auditing.

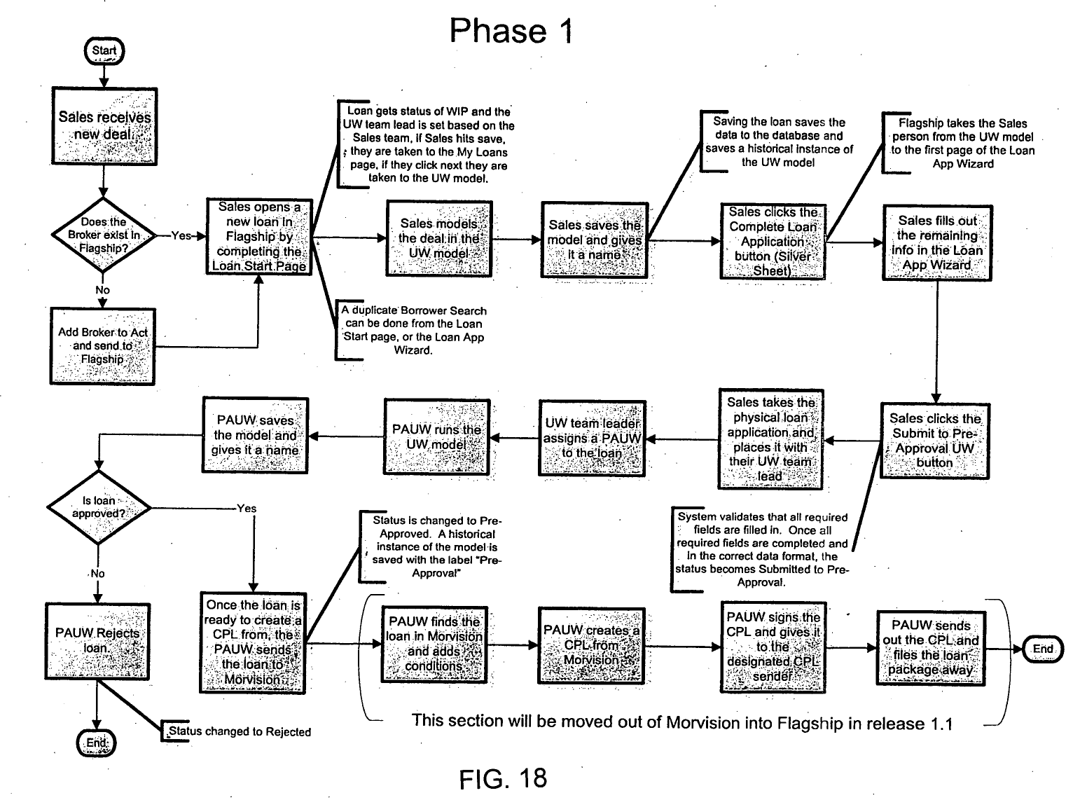

FIG. 18 shows a flow chart for an embodiment of the loan processing system and method of the present invention.

Specific workflow tasks and notifications in an embodiment of the loan processing system and method of the present invention will now be described herein with reference to the figures. An embodiment of the invention includes a method, system, and computer-product for managing workflow for a loan processing system, including: providing a workflow for a loan processing system comprising tasks and notifications, the workflow defined as a logical sequence of interdependent tasks to be performed to complete processing of a loan from initial input to closing, each task having an associated status, wherein the status is either resolved or not resolved; grouping related tasks and notifications into sets; displaying one or more of the workflow tasks in a logical order and upon satisfaction of predetermined conditions and wherein the at least one of the displayed tasks require input from a user; receiving input from a user to change the status of a task to resolved; outputting one or more notifications linked to certain of the workflow tasks, wherein the notifications do not require input from a user; and processing a loan application through the workflow. Each of the tasks can require a status of resolved before displaying the next one or more of the workflow tasks in the logical order and each of the displayed tasks can require input from a user.

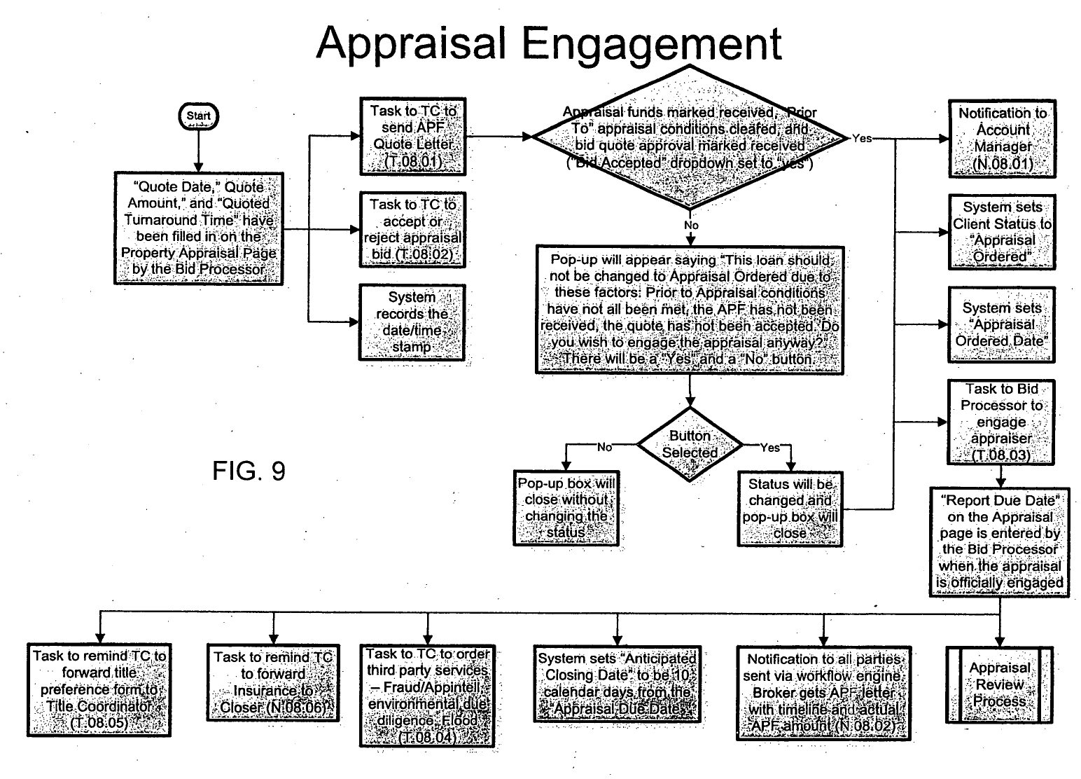

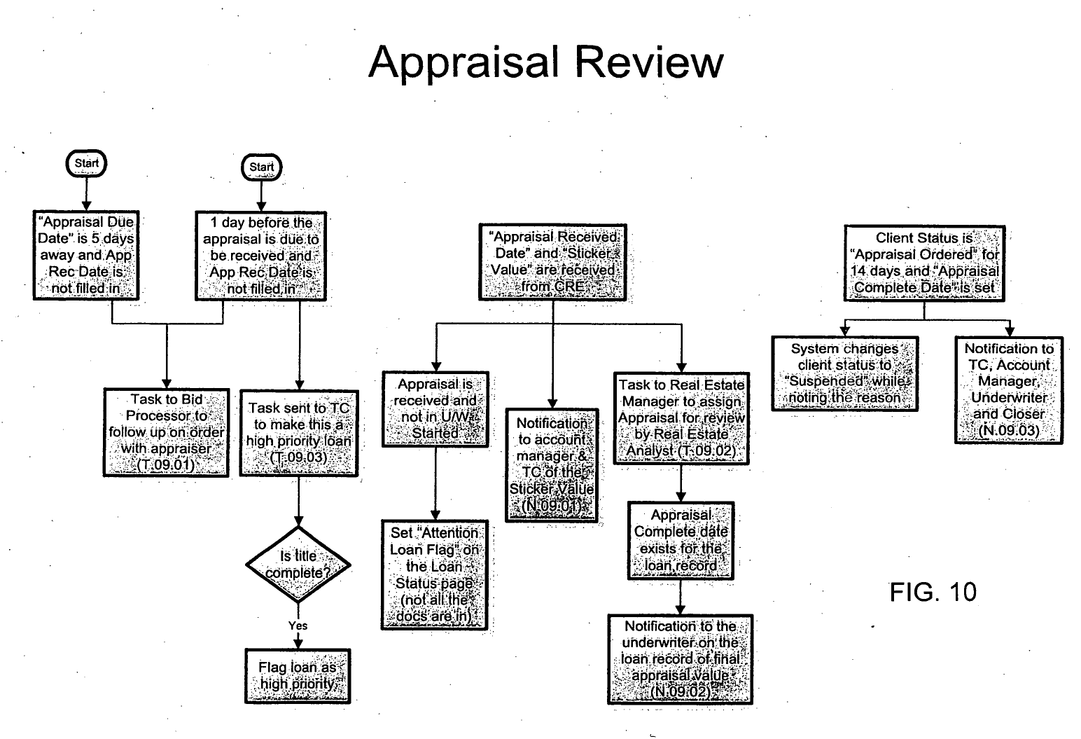

The sets comprise one or more of an initial input set (FIG. 2), a pre-approval underwriting set (FIG. 3), a conditional pre-approval distribution processing set (FIG. 4), a loan file assignment set (FIG. 5), a processing set (FIG. 6), a loan term changing set (FIG. 7), an appraisal fee quote request set (FIG. 8), an appraisal engagement set (FIG. 9), an appraisal review set (FIG. 10), an initial final underwriting review phase one set (FIG. 11), an initial final underwriting review phase two set (FIG. 12), a final review phase one set (FIG. 13), a final review phase two set (FIG. 14), an ordering title set (FIG. 15), a closing set (FIG. 16), and a legal transactions set (FIG. 17).

In the initial input set (FIG. 2), tasks include: T.01.01 of “Task to Loan Opener to ‘clack in’ remaining loan application data for selected loan”; and T.01.02 of “Task to Pre-Approval Underwriter (“PAUWZ”) Leader to assign loan to a Pre-Approval Underwriter.” Notifications include N.01.01 of “confirmation to Sales that loan has been received by Loan Opener (“LO”). Once the task of T.01.01 is resolved, the Client Status is changed to “Pending Pre-Approval.”

Next, in the pre-approval underwriting set (FIG. 3), task T.01.02 is resolved and tasks in this set include T.02.01 “Task to PAUW to underwrite loan and provide pre-approval decision signature on the loan.” If the decision signature page is approved, task T.02.01 is resolved and system sets “Pre-Approval date.” The next task T.02.02 is “Task to Loan Opener to mail CPL.”

Following, in the conditional pre-approval distribution processing set (FIG. 4), the Loan Opener receives the signed CPL and file form PAUW and task T.02.02 is resolved, and the system sets “CPL Sent Date” and a notification N.03.01 is sent to the Account Manager. If it is not a CPL change, the next task is T.03.01 of “Task to Processing Team Lead to assign a Transaction Coordinator to the loan.”

In the loan file assignment set (FIG. 5), a decision step includes whether or not the CPL arrives in 7 days. If not, the CPL sent date is 7 days old and the CPL Accepted date has not been set, task T.05.06 “Task to Account Manager to follow up with Broker” is generated as well as notification N.05.01 “1-day Notification that CPL is about to expire.” If the CPL does not arrive in 14 days, the CPL Sent date is 14 days old and the CPL accepted date has not been set, and the system changes the loan status to CPL expired and notification N.05.02 “Notification to TC, processor—withdrawn files, and Account Manager to inform them of the status change” is sent. Otherwise, if the CPL comes in 7 or 14 days, the checklist condition “CPL Received” is resolved by the Processing Manager. The system sets the Accepted Date. The task T.05.02 “Task to Transaction Coordinator (“TC”) to produce and send Introductory Package” is generated and task T.05.03 “Task to TC to make introductory phone call to broker” is generated. Also, task T.05.01 “Task to Closing Team Lead to assign a Closer to the file” is generated. Further, task T.05.04 “Task to Paralegal Team Lead to assign a Paralegal to the file” is generated. Moreover, task T.05.05 “Task to Title Coordinator Team Lead to assign a Title Coordinator to the file” is generated. Notification N.05.03 “Notification to Sales as to the identity of the TC and what conditions are needed to engage the appraiser and if more money is needed to engage” is sent. After an outside appraisal submitted date is set by the TC, the system resolves the “New loan assigned” task T.07.01.

In the processing set (FIG. 6), a number of processes are completed. If the Client Status is CPL Accepted for 14 days and the APF payment has not been completed, then notification N.06.01 is sent to the TC, the Account Manager, the Underwriter and the Closer, and the system changes status to suspended while noting the reason—loan has gone into suspended. If the conditions are not cleared, task T.06.05 is generated to the TC that the loan is a high priority and to clear the conditions that will take out it of suspended status. If the conditions are cleared, and if the loan is in a suspended status and all outstanding conditions have been received, then task T.06.01 is generated to the Underwriter to remove the suspension. A pop-up window will appear if the TC attempts to change status based upon certain factors. If the prior-to-underwriting conditions are cleared and the appraisal is ordered, then the system changes to status underwriting started and proceeds to initial underwriting review. In view of the pop-up, if the TC wants to start underwriting anyway, then the status will be changed and the box will close. If a title anticipated closing date has passed, then task T.06.02 is generated to the TC notifying that the date needs to be updated. If a title preference form is returned, then notification N.06.02 is sent to the Title Coordinator that the form is in and notification N.06.03 is sent to remind the TC that certain pages of the contract need to be given with the Title Preference Form and the process proceeds to ordering title. If the account manger selects a request to expedite and enters a reason, then task T.06.03 is generated to the sales director and the processing manager to provide an OK to Expedite decision signature. If the loan is copied to be a SHF 2nd mortgage loan and existing loan, then task T.06.04 is generated to the Title Coordinator to order title for the second mortgage.

In the CPL/loan term changing set (FIG. 7), the loan terms change request page is completed and is submitted by sales, and the ad task T.04.01 is generated to the Pre-Approval Underwriter (“PAUW”) to re-run the model and re-sign the decision signature page. If, before the appraisal is ordered, the PAUW receives the physical file from sales or if, after the appraisal is ordered, the PAUW receives file from the TC, then the PAUW selects “Apply changes” to load the requested loan terms and the PAUW reruns the model with new data. If the status is declined, then suggestions are offered and, if the broker does not want to keep old loan terms, the loan is rejected. If the broker wants to keep the old terms, then the CPL/Loan Term change is voided. Otherwise, if it is approved, then, before appraisal, task T.02.01 is resolved, task T.02.02 is generated to have the loan opener mail CPL. The PAUW prints the CPL and signs it and the process proceeds to CPL distribution. After the appraisal, the CPL and the Loan terms change date is filled and added to the events log. After the final loan terms sheet is out, the process proceeds to the final review process.

In the appraisal fee quote request set (FIG. 8), task T.07.01 “Task to Bid Processor to inform that a new loan has been opened and to order a new bid” is generated. Also generated is Task T.07.02 “Task to Real Estate Manager to decide on appraisal type” along with Notification N.07.01 “Notification to inform Bid Processor of Appraisal type.” If the bid information is correct, the quote is ordered and the appraisal engagement process begins.

In the appraisal engagement set (FIG. 9), once appropriate data is completed by the Bid Processor, certain tasks are generated, including task T.08.01 “Task to TC to send APF Quote letter,” and task T.08.02 “Task to TC to accept or reject appraisal bid.” Date and time stamps are recorded. Provided that all prior-to-appraisal conditions are met, additional tasks and notifications are generated. Specifically, notification N.08.01 notifies the Account Manager, the system sets the Client Status to “Appraisal Ordered,” and also sets the “Appraisal Ordered Date.” Task T.08.03 “Task to Bid Processor to engage appraiser” is generated” and the “Report Due Date” on the Appraisal page is entered by the Bid Processor when the appraisal is officially engaged. Additional tasks include task T.08.05 “Task to remind TC to forward title preference form to Title Coordinator,” task T.08.06 “Task to remind TC to forward insurance to the Closer,” task T.08.04 Task to TC to order third party services—Fraud/Appintell environmental due diligence, flood, etc.” The system then sets the “Anticipated Closing Date” to be 10 calendar days from the “Appraisal Due Date.” Notification N.08.02 “Notification to all parties sent through workflow engine, broker gets APF letter with timeline and actual APF amount” is sent. Next, workflow proceeds to the Appraisal. Review Process.

In the appraisal review set (FIG. 10), one process where the “Appraisal Due Date” is 5 days away and the Appraisal Recording Date is not filled in generates the task T.09.01 “Task to Bid Processor to follow up on order with appraiser”. Another process where it is 1 day before the appraisal is due to be received and the Appraisal Recording Date is not filled in, task T.09.01 is generated and task T.09.03 “Task sent to TC to make this a high priority loan” is sent. If title is complete, the loan is flagged as a high priority. Upon receipt of the “Appraisal Received Date” and “Sticker Value” from CRE—an internal system that handles appraisal information, a number of tasks and notifications are generated. If the Appraisal is received and underwriting is not started, the flag “Attention Loan Flag” is set on the Loan Status page, meaning that not all of the documents are in. Notification N.09.01 “Notification to Account Manager & TC of the Sticker Value” is sent. Also, task T.09.02 “Task to Real Estate Manager to assign Appraisal for review by real estate analyst” is generated. The appraisal complete date exists for the loan records and notification N.09.02 “Notification to the Underwriter on the loan record of final appraisal value” is sent. If the Client Status is “Appraisal Ordered” for 14 days and “Appraisal Complete Date” is set, then the system changes to “Suspended” while noting a reason(s) for the suspension and notification N.09.03 “Notification to TC, Account Manager, Underwriter ad closer” is sent.

In the initial final underwriting review phase one set (FIG. 11), the status is changed to “Underwriting Started”, the Final Underwriter (FUW) is notified by the TC that loan status has changed, the Underwriter updates information from MORvision into the system, the FUW assesses the loan, final underwriting conditions are added, the file is given back to the TC, and the loan status is changed to “UW in Review.” If the Client Status is “UW in Review” for 14 days and “Appraisal Complete Date” is set, then, if the appraisal is still pending, the TC, the Account Manager, the Underwriter and the Closer are notified and a task is generated to the TC to change the status to Suspended while noting a reason therefor. If Prior-to-Underwriting conditions are not cleared, the status changes to Suspended and the TC, the Account Manager, the Underwriter and the Closer are notified. Otherwise, the Client Status is “Underwriting in Review” all Prior-to-Final Underwriting conditions have been cleared, and the “Appraisal complete date” has been set. A task is generated to the Final Underwriter to explain that final analysis is ready to be performed and the process proceeds to the Final Review Process.

In the initial final underwriting review phase two set (FIG. 12), the status is changed to “Underwriting started” and task T.11.01 “Task to TC to order credit” is generated. If the Client Status is “UW in Review” for 14 days and “Appraisal Complete date” is set, and if the appraisal is still pending, the system changes the status to “suspended” while noting a reason(s) therefor and notification N.11.01 is sent to the TC, the Account Manager, the Underwriter and the Closer. If Prior-to-Underwriting conditions are not cleared, then the status changes to suspended and the TC, the Account Manager, the Underwriter and the Closer are notified N.11.02. Otherwise, the Client Status is “Underwriting in Review,” all Prior-to-Final Underwriting conditions have been cleared, and the “Appraisal complete date” has been set. A task (N.11.03) is generated to the Final Underwriter to explain that the final underwriting analysis is ready to be performed, and the process proceeds to the Final Review.

In the final review Phase I set (FIG. 13), the TC gives the file back to the FUW once all conditions are in and the FUW performs a final assessment and re-runs the model. If a declined result is obtained, suggestions are offered on how to make the deal work to the Account Manager and the loan is rejected. Otherwise, the Client Status is changed to “Underwriting Complete” and a task is generated to the Final Underwriter to produce the final loan terms sheet, to send the loan file to the TC, to give an OK to close (to get all required signatures), and the Account Manager, the TC, and the Closer are notified that the loan has been approved by final underwriting. This includes a list of all outstanding conditions. The process then proceeds to Phase II.

In the final review Phase II set (FIG. 14), the Client Status is changed to Underwriting Complete and task T.13.01 is generated to the Final Underwriter, the FUW team lead, the TC, the Processing Team lead, the Closer, and the Closing team lead to provide an OK to Close decision signature. In an OK to close status, all required signatures are obtained and notification N.13.01 is sent to the Account Manager, the TC, and the Closer that the loan has been approved by final underwriting. This includes a list of all outstanding conditions. Task T.13.02 is generated to the Final Underwriter to produce the Final Loan Terms sheet and the physical loan file is sent to the TC. The process then proceeds to closing.

In the ordering title set (FIG. 15), task T.05.05 is generated to assign a Title Coordinator by the team lead, notification N.4.01 is sent to the Title Coordinator that a new loan has been assigned, checklist condition “Title Preference Form Received” is cleared, and task T.14.01 to Title Coordinator to order title is generated. A Title Received Date is saved in the system. Task T.05.04 is generated to assign a paralegal and notification N.14.02 is sent to the assigned paralegal that the new loan has been assigned. Task T.14.02 is generated to the paralegal to review title. After the paralegal performs the review, notification N.14.03 is sent to the Closer that title has been completed. A title completed date is saved and, if rejected, the loan is rejected. Otherwise, the loan status is changed to final approval, and notification N.14.04 is sent to the TC. The process then proceeds to closing.

In the closing set (FIG. 16), task T.05.01 is generated, in which the Closer is assigned by the team lead and notification N.15.01 is sent to the Closer indicating that the new loan has been assigned. If the loan status is UW Complete for 7 days, then the system changes the status to Suspended while noting a reason(s) therefor and notification N.15.02 is sent to the TC, the Account Manager, the Underwriter and the Closer. If the loan status is Final Approval for 7 days then the system changes the status to Suspended while noting a reason(s) therefor and notification N.15.03 is sent to the TC, the Account Manager, the Underwriter and the Closer. If a checklist item “Final Term Sheet Sent” has been checked for 5 days but the final loan terms sheet received item is not checked, then task T.15.01 is generated to the Closer to have the Closer follow up with the broker/borrower. If the closing date is saved as firm, then notification N.15.04 is sent to the Account Manager and the TC, and task T.15.02 is generated to the Closer to send a pre-closing letter to the customer, and, if hazard insurance is received by the TC, then notification N.15.05 is sent to the Closer that hazard insurance is received. Processes are performed including the clearing of condition groups (appraisal, approval), etc.) and task T.15.02 is resolved.

In the legal transactions set (FIG. 17), a checklist item “broker fee agreement received” is checked and the Client Status is set to either Underwriting Complete or Final Approval. Then, task T.16.01 is generated to the paralegal to cause the paralegal to create the desired legal documents.

Based on the foregoing specification, the invention may be implemented using computer programming or engineering techniques including computer software, firmware, hardware or any combination or subset thereof. Any such resulting program, having computer-readable code measures, may be embodied or provided within one or more computer-readable media, thereby making a computer program product, i.e., an article of manufacture, according to the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will easily be able to combine the software created as described with appropriate general purpose or special purpose computer hardware to create a computer system or computer sub-system embodying the method of the invention. An apparatus for making, using or selling the invention may be one or more processing systems including, but not limited to, a central processing unit (CPU), memory, storage devices, communication links and devices, servers, I/O devices, or any sub-components of one or more processing systems, including software, firmware, hardware or any combination or subset thereof, which embody the invention. User input may be received from the keyboard, mouse, pen, voice, touch screen, or any other measures by which a human can input data into a computer, including through other programs such as application programs.

It should be understood that the examples and embodiments described herein are for illustrative purposes only and that various modifications or changes in light thereof will be suggested to persons skilled in the art and are to be included within the spirit and purview of this application and the claims.

We claim:

1. A method for managing workflow for a loan processing system, which comprises
providing a workflow for a loan processing system comprising tasks and notifications, the workflow defined as a logical sequence of interdependent tasks to be performed to complete processing of a loan from initial input to closing, each task having an associated status, wherein the status is either resolved or not resolved;
grouping related tasks and notifications into sets;
displaying a plurality of the workflow tasks in a logical order and upon satisfaction of predetermined conditions and wherein at least one of the displayed tasks require input from a user to set the status;
receiving input from a user to change the status of the at least one task to resolved;
outputting one or more notifications linked to certain of the workflow tasks, wherein the notifications do not require input from a user; and
processing a loan application through the workflow.

2. The method according to claim 1, wherein the sets comprise one or more of an initial input set, a pre-approval underwriting set, a conditional pre-approval distribution processing set, a loan file assignment set, a processing set, a loan term changing set, an appraisal fee quote request set, an appraisal engagement set, an appraisal review set, an initial final underwriting review phase one set, an initial final underwriting review phase two set, a final review phase one set, a final review phase two set, an ordering title set, a closing set, and a legal transactions set.

3. The method according to claim 1, wherein: the tasks require a status of resolved before displaying the next one or more of the workflow tasks in the logical order; and each of the displayed tasks require input from a user;

4. A system for managing workflow for a loan processing system, comprising:
a data module comprising a workflow for a loan processing system comprising a plurality of workflow tasks and notifications, said workflow defined as a logical sequence of interdependent tasks to be performed to complete processing of a loan from initial input to closing, each task having an associated status, wherein said status is either resolved or not resolved; wherein related tasks and notifications are grouped into sets;
a display for displaying one or more of said workflow tasks in a logical order and upon satisfaction of predetermined conditions and wherein at least one of said displayed tasks require input from a user;
an input device for receiving input from a user to change said status of said at least one task to resolved;
an output device outputting one or more notifications linked to certain of said workflow tasks, wherein said notifications do not require input from a user; and
a processor for processing a loan application through said workflow.

5. The system according to claim 4, wherein the sets comprise one or more of an initial input set, a pre-approval underwriting set, a conditional pre-approval distribution processing set, a loan file assignment set, a processing set, a loan term changing set, an appraisal fee quote request set, an appraisal engagement set, an appraisal review set, an initial final underwriting review phase one set, an initial final underwriting review phase two set, a final review phase one set, a final review phase two set, an ordering title set, a closing set, and a legal transactions set.

6. The system according to claim 4, wherein said tasks require a status of resolved before displaying a next one or more of said workflow tasks in the logical order, and wherein each of said displayed tasks require input from a user.

7. A computer program product comprising a computer useable medium having computer program logic stored therein, said computer program logic for:
providing a workflow for a loan processing system comprising tasks and notifications, the workflow defined as a logical sequence of interdependent tasks to be performed to complete processing of a loan from initial input to closing, each task having an associated status, wherein the status is either resolved or not resolved;
grouping related tasks and notifications into sets;
displaying one or more of the workflow tasks in a logical order and upon satisfaction of predetermined conditions and wherein at least one of the displayed tasks require input from a user;
receiving input from a user to change the status of the at least one task to resolved;
outputting one or more notifications linked to certain of said workflow tasks, wherein said notifications do not require input from a user; and
processing a loan application through said workflow.

8. The computer program product according to claim 7, wherein the sets comprise one or more of an initial input set, a pre-approval underwriting set, a conditional pre-approval distribution processing set, a loan file assignment set, a processing set, a loan term changing set, an appraisal fee quote request set, an appraisal engagement set, an appraisal review set, an initial final underwriting review phase one set, an initial final underwriting review phase two set, a final review phase one set, a final review phase two set, an ordering title set, a closing set, and a legal transactions set.

9. The computer program product according to claim 7, wherein the tasks require a status of resolved before displaying the next one or more of the workflow tasks in the logical order, and wherein each of the displayed tasks require input from a user.

10. A method of dynamically interfacing with a rules engine in a browser-based client/server application to update a portion of a webpage without re-loading the entire page comprising:
displaying a user interface in a browser as a webpage including an input field for receiving user input and a results field for displaying the results after application of a rule;
in response to the input field receiving user input, executing a request to a rules engine using asynchronous scripting;
returning an output to the user interface after application of a rule; and displaying the output in the results field without re-loading the entire webpage.

11. The method according to claim 10, wherein the asynchronous scripting is Asynchronous JavaScript and XML.

12. The method according to claim 10 wherein the results field is a drop down selection box that changes based on the application of the rule.

13. A computer program product for dynamically interfacing with a rules engine in a browser-based client/server application to update a portion of a webpage without re-loading the entire page comprising a computer useable medium having computer program logic stored therein, the computer program logic for: displaying a user interface in a browser as a webpage including an input field for receiving user input and a results field for displaying the results after application of a rule; in response to the input field receiving user input, executing a request to a rules engine using asynchronous scripting;
returning an output to the user interface after application of a rule; and
displaying the output in the results field without re-loading the entire webpage.

14. The method according to claim 13, wherein the asynchronous scripting is Asynchronous JavaScript and XML.

15. The method according to claim 13, wherein the results field is a drop down selection box that changes based on the application of the rule.

16. A graphical user interface program having computer executable instructions stored on a computer readable medium, the graphical user interface program comprising:
means for:
displaying a user interface in a browser as a webpage including an input field for receiving user input and a results field for displaying the results after application of a rule;
in response to the input field receiving user input, executing a request to a rules engine using asynchronous scripting;
returning an output to the user interface after application of a rule; and
displaying the output in the results field without re-loading the entire webpage.
